(19) United States
(12) Patent Application Publication
(10) Pub. No.: US 2017/0309039 A1
(43) Pub. Date: Oct. 26, 2017

(54) IMAGE PROCESSING APPARATUS AND X-RAY DIAGNOSIS APPARATUS

(71) Applicant: Toshiba Medical Systems Corporation, Otawara-shi (JP)

(72) Inventors: Yuichiro WATANABE, Yaita (JP); Takuya SAKAGUCHI, Utsunomiya (JP)

(73) Assignee: Toshiba Medical Systems Corporation, Otawara-shi (JP)

(21) Appl. No.: 15/497,490

(22) Filed: Apr. 26, 2017

(30) Foreign Application Priority Data
Apr. 26, 2016 (JP) 2016-088165

(51) Int. Cl. G06T 7/73

(52) U.S. Cl. CPC G06T 7/73; G06T 2207/10116; G06T 2207/20172

(57) ABSTRACT

An image processing apparatus includes a processing circuitry configured: to generate an enhanced image in which an object is enhanced from each of sequentially-generated X-ray images; to detect the position of the object included in each of the generated enhanced images; to determine, while using the position of the object detected from a specific one of the enhanced images as a reference position, processing details of a correcting process performed to arrange the detected position of the object to match the reference position, with respect to each of the enhanced images generated after the specific enhanced image; to sequentially generate corrected images by performing the correcting processes according to the processing details determined for each of the enhanced images, on the X-ray images from which the enhanced images were generated; and to cause a display to display the sequentially-generated corrected images as a moving picture.

### CROSS-REFERENCE TO RELATED APPLICATIONS

This application is based upon and claims the benefit of priority from Japanese Patent Application No. 2016-088165, filed on Apr. 26, 2016; the entire contents of which are incorporated herein by reference.

### FIELD

Embodiments described herein relate generally to an image processing apparatus and an X-ray diagnosis apparatus.

### BACKGROUND

Endovascular intervention treatments are performed by implementing a treatment method by which a treatment tool (a device) called a catheter is inserted into a blood vessel so as to treat an affected area in the heart, the brain, the liver, or the like. For example, to perform an endovascular intervention treatment, a medical doctor inserts a catheter with a balloon up to a stenosis site. After that, for example, the medical doctor expands the balloon by injecting liquid into the balloon via the catheter. As a result, the stenosis site is mechanically expanded so that the blood flow is recovered. After the liquid in the balloon is sucked out, the catheter with the balloon is pulled out of the body of the subject by the medical doctor.

Further, an endovascular intervention treatment can also be performed by using a catheter with a balloon that has a metal mesh (called a stent) being in close contact therewith on the outside thereof, for the purpose of preventing recurrence of stenosis in a stenosis site that was once expanded by the balloon. According to this treatment method, a medical doctor expands the stent by expanding the balloon, and subsequently, the liquid in the balloon is sucked out so as to pull the catheter out of the body of the subject. As a result, the expanded stent is left at the stenosis site, and it is therefore possible to reduce the possibility of stenosis recurring at the stenosis site.

To perform endovascular intervention treatments, it is required to move the device inserted in the blood vessel up to the treated site with an adequate level of precision. Normally, the position of the device is determining by referring to X-ray images that are generated and displayed by an X-ray diagnosis apparatus in a real-time manner. For this reason, in two locations (or in one location), the device has attached thereto metal pieces through which X-rays do not pass, for example, as markers indicating the positions of the balloon or the stent. The medical doctor determines the position of the device by referring to the one or more markers rendered in the X-ray images displayed on a monitor.

However, when an endovascular intervention treatment is performed on a blood vessel in an organ constantly having a pulsating motion such as the heart or in an organ moving due to the pulsating motion, the position of the device in the X-ray images moves constantly. Thus, determining the position of the device while referring to the X-ray images requires an extremely high level of skills of the medical doctor.

To cope with this situation, a technique is conventionally known by which, for example, a moving picture in which the device virtually appears to be stationary is displayed by tracking markers at two points that are rendered in sequentially-generated X-ray images and deforming the images in such a manner that the positions of the markers at the two points in the X-ray images are in the same positions as those in a past image. Further, as a post-processing process, another technique is also known by which the device is displayed in an enhanced manner with high contrast, for example, by calculating an arithmetic mean of images in a plurality of frames that have been corrected to arrange the positions of the markers at two points to be the same among the images.

### BRIEF DESCRIPTION OF THE DRAWINGS

FIG. 1 is a diagram illustrating an exemplary configuration of an X-ray diagnosis apparatus according to a first embodiment;

FIGS. 2A and 2B are drawings for explaining a process performed by a detecting function according to the first embodiment;

FIG. 3 is a drawing for explaining an example of a Learning Mode according to the first embodiment;

FIGS. 4A and 4B are drawings for explaining a process performed by a corrected image generating function according to the first embodiment;

FIG. 5 is a drawing for explaining an example of a Tracking Mode according to the first embodiment;

FIG. 6 is a drawing for explaining a single-point fixation process according to the first embodiment;

FIG. 7 is a drawing for explaining an example of a process performed by a determining function according to the first embodiment;

FIG. 8 is a drawing for explaining an example of a process performed by the corrected image generating function according to the first embodiment;

FIG. 9 is a flowchart illustrating a processing procedure performed by an X-ray diagnosis apparatus according to the first embodiment;

FIG. 10 is a drawing for explaining an example of a process performed by a corrected image generating function according to a second embodiment; and

FIG. 11 is a flowchart illustrating a processing procedure performed by an X-ray diagnosis apparatus according to the second embodiment.

### DETAILED DESCRIPTION

According to an embodiment, an image processing apparatus includes a processing circuitry. The processing circuitry is configured to generate an enhanced image in which an object is enhanced from each of sequentially-generated X-ray images. The processing circuitry is configured to detect a position of the object included in each of the generated enhanced images. The processing circuitry is configured to determine, while using the position of the object detected from a specific one of the generated enhanced images as a reference position, processing details of a correcting process performed to arrange the detected position of the object to match the reference position, with respect to each of the enhanced images generated after the specific enhanced image. The processing circuitry is configured to sequentially generate corrected images by performing the correcting processes according to the processing details determined for each of the enhanced images, on the X-ray images from which the enhanced images were generated. The processing circuitry is configured to cause a display to display the sequentially-generated corrected images as a moving picture.

Exemplary embodiments of an image processing apparatus and an X-ray diagnosis apparatus will be explained in detail below, with reference to the accompanying drawings. Image processing apparatuses and X-ray diagnosis apparatuses of the present disclosure are not limited to those described in the embodiments below. In the following sections, embodiments of an X-ray diagnosis apparatus will be explained as an example.

### First Embodiment

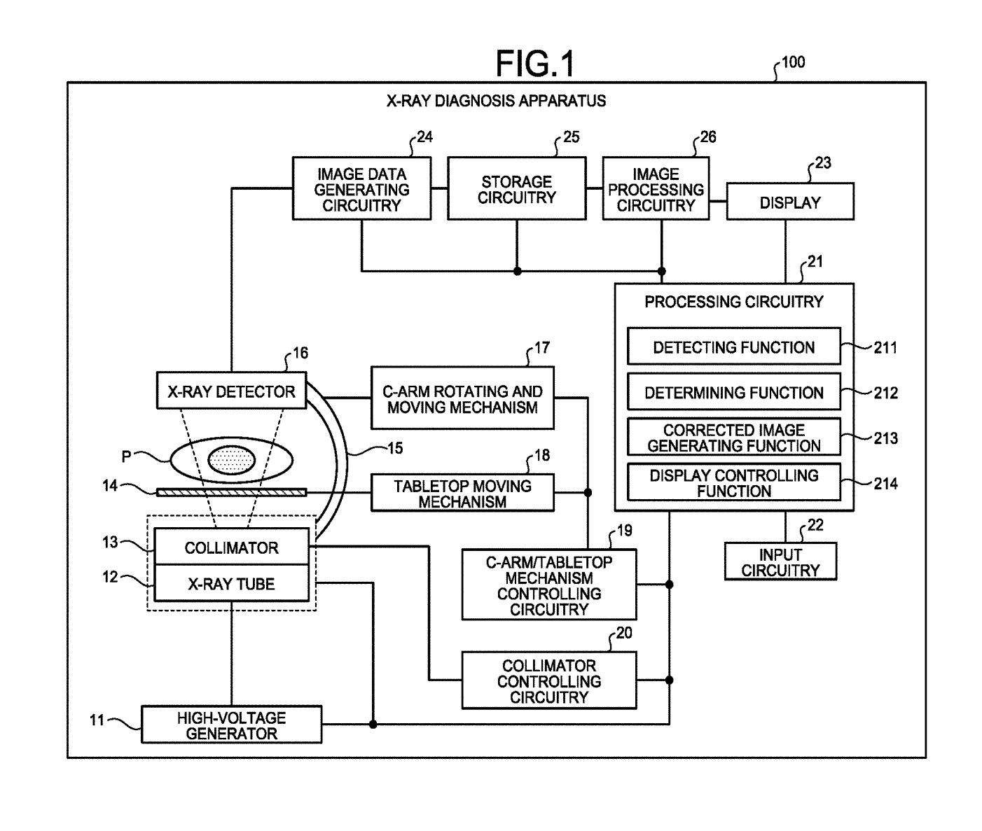

First, an overall configuration of an X-ray diagnosis apparatus according to a first embodiment will be explained. FIG. 1 is a diagram illustrating an exemplary configuration of an X-ray diagnosis apparatus 100 according to the first embodiment. As illustrated in FIG. 1, the X-ray diagnosis apparatus 100 according to the first embodiment includes a high-voltage generator 11, an X-ray tube 12, a collimator 13, a tabletop 14, a C-arm 15, an X-ray detector 16, a C-arm rotating and moving mechanism 17, a tabletop moving mechanism 18, C-arm/tabletop mechanism controlling circuitry 19, collimator controlling circuitry 20, processing circuitry 21, input circuitry 22, a display 23, image data generating circuitry 24, storage circuitry 25, and image processing circuitry 26.

In the X-ray diagnosis apparatus 100 illustrated in FIG. 1, processing functions thereof are stored in the storage circuitry 25 in the form of computer-executable programs. The C-arm/tabletop mechanism controlling circuitry 19, the collimator controlling circuitry 20, the processing circuitry 21, the image data generating circuitry 24, and the image processing circuitry 26 are processors each configured to realize the function corresponding to a different one of the programs by reading and executing the program from the storage circuitry 25. In other words, each of the circuits that has read the corresponding one of the programs has the function corresponding to the read program.

The term “processor” used in the explanation above denotes, for example, a circuit such as a Central Processing Unit (CPU), a Graphics Processing Unit (GPU), an Application Specific Integrated Circuit (ASIC), a programmable logic device (e.g., a Simple Programmable Logic Device [SPLD], a Complex Programmable Logic Device [CPLD]), or a Field Programmable Gate Array (FPGA). Each of the processors realizes the function thereof by reading and executing a corresponding one of the programs stored in the storage circuitry. Alternatively, it is also acceptable to directly incorporate the program into a circuit of each of the processors, instead of having the programs stored in the storage circuitry. In that situation, each of the processors realizes the function thereof by reading and executing the program incorporated in the circuit thereof. Each of the processors described in the first embodiment does not necessarily have to be configured as a single circuit individually. For instance, a plurality of independent circuits may be combined together to structure a single processor so as to realize the functions thereof.

The high-voltage generator 11 is configured to generate a high voltage and supply the generated high voltage to the X-ray tube 12 under control of the processing circuitry 21. The X-ray tube 12 is configured to generate X-rays by using the high voltage supplied from the high-voltage generator 11.

The collimator 13 is configured to limit the X-rays generated by the X-ray tube 12 so as to be selectively radiated onto a region of interest of an examined subject P, under control of the collimator controlling circuitry 20. For example, the collimator 13 includes four slidable collimator blades. Under the control of the collimator controlling circuitry 20, the collimator 13 limits the X-rays generated by the X-ray tube 12 so as to be radiated onto the subject P, by sliding the collimator blades. The tabletop 14 is a bed on which the subject P is placed and is arranged on a table (not illustrated). In this situation, the subject P is not included in the X-ray diagnosis apparatus 100.

The X-ray detector 16 is configured to detect X-rays that have passed through the subject P. For example, the X-ray detector 16 includes detecting elements arranged in a matrix formation. The detecting elements are configured to convert the X-rays that have passed through the subject P into electrical signals, to accumulate the electrical signals therein, and to transmit the accumulated electrical signals to the image data generating circuitry 24.

The C-arm 15 is configured to hold the X-ray tube 12, the collimator 13, and the X-ray detector 16. The X-ray tube 12 with the collimator 13 and the X-ray detector 16 are arranged by the C-arm 15 so as to oppose each other while the subject P is interposed therebetween. Although FIG. 1 illustrates an example in which the X-ray diagnosis apparatus 100 is a single-plane apparatus, possible embodiments are not limited to this example. The X-ray diagnosis apparatus 100 may be a biplane apparatus.

The C-arm rotating and moving mechanism 17 is a mechanism used for rotating and moving the C-arm 15. The C-arm rotating and moving mechanism 17 is also capable of changing a Source Image receptor Distance (SID) indicating the distance between the X-ray tube 12 and the X-ray detector 16. Further, the C-arm rotating and moving mechanism 17 is also capable of rotating the X-ray detector 16 held by the C-arm 15. The tabletop moving mechanism 18 is a mechanism used for moving the tabletop 14.

The C-arm/tabletop mechanism controlling circuitry 19 is configured to adjust the rotating and the moving of the C-arm 15 and the moving of the tabletop 14, by controlling the C-arm rotating and moving mechanism 17 and the tabletop moving mechanism 18, under the control of the processing circuitry 21. The collimator controlling circuitry 20 is configured to control the radiation range of the X-rays radiated onto the subject P, by adjusting the opening degree of the collimator blades included in the collimator 13, under the control of the processing circuitry 21.

The image data generating circuitry 24 is configured to generate image data by using the electrical signals converted from the X-rays by the X-ray detector 16 and to store the generated image data into the storage circuitry 25. For example, the image data generating circuitry 24 generates the image data by applying a current/voltage conversion, an Analog/Digital (AD) conversion, and/or a parallel/serial conversion to the electrical signals received from the X-ray detector 16. Further, the image data generating circuitry 24 stores the generated image data into the storage circuitry 25.

The storage circuitry 25 is configured to receive and store therein the image data generated by the image data generating circuitry 24. Further, the storage circuitry 25 stores therein the programs corresponding to the various types of functions that are read and executed by the circuitry illustrated in FIG. 1. In one example, the storage circuitry 25 stores therein a program corresponding to a detecting function 211, a program corresponding to a determining function 212, a program corresponding to a corrected image generating function 213, and a program corresponding to a display controlling function 214 that are read and executed by the processing circuitry 21.

The image processing circuitry 26 is configured, under the control of the processing circuitry 21 described below, to generate an X-ray image by performing various types of image processing processes on the image data stored in the storage circuitry 25. Alternatively, the image processing circuitry 26 is configured, under the control of the processing circuitry 21 described below, to generate an X-ray image by obtaining image data directly from the image data generating circuitry 24 and performing various types of image processing processes on the obtained image data. Further, the image processing circuitry 26 is also capable of storing the X-ray image on which any of the image processing process has been performed, into the storage circuitry 25. For example, the image processing circuitry 26 is capable of performing various types of processes using an image processing filter such as a moving average (smoothing) filter, a Gaussian filter, a median filter, a recursive filter, a band-pass filter, or the like.

The input circuitry 22 is realized with a trackball, a switch button, a mouse, and/or the like used for setting a region (e.g., a region of interest such as a site of interest), as well as a foot switch or the like used for performing the radiation of the X-rays. The input circuitry 22 is connected to the processing circuitry 21 and is configured to convert an input operation received from the operator into an electrical signal and to output the electrical signal to the processing circuitry 21. The display 23 is configured to display a Graphical User Interface (GUI) used for receiving an instruction from the operator and various types of images generated by the image processing circuitry 26.

The processing circuitry 21 is configured to control operations of the entirety of the X-ray diagnosis apparatus 100. More specifically, the processing circuitry 21 is configured to perform various types of processes by reading and executing a program corresponding to a controlling function to control the entire apparatus, from the storage circuitry 25. For example, the processing circuitry 21 controls the dose and the turning off and on of the X-rays radiated onto the subject P, by controlling the high-voltage generator 11 according to an instruction from the operator transferred thereto from the input circuitry 22 so as to adjust the voltage supplied to the X-ray tube 12. Further, for example, the processing circuitry 21 controls the C-arm/tabletop mechanism controlling circuitry 19 according to an instruction from the operator so as to adjust the rotating and the moving of the C-arm 15 and the moving of the tabletop 14. Further, for example, the processing circuitry 21 controls the radiation range of the X-rays radiated onto the subject P, by controlling the collimator controlling circuitry 20 according to an instruction from the operator so as to adjust the opening degree of the collimator blades included in the collimator 13.

Further, the processing circuitry 21 controls the image data generating process performed by the image data generating circuitry 24, the image processing processes performed by the image processing circuitry 26, and an analyzing process, according an instruction from the operator. Further, the processing circuitry 21 exercises control so that the display 23 displays the GUI used for receiving an instruction from the operator and any of the images stored in the storage circuitry 25. In this situation, as illustrated in FIG. 1, the processing circuitry 21 according to the first embodiment executes the detecting function 211, the determining function 212, the corrected image generating function 213, and the display controlling function 214, and details thereof will be explained later. The processing circuitry 21 described above is an example of the processing circuitry set forth in the claims.

An overall configuration of the X-ray diagnosis apparatus 100 has thus been explained. The X-ray diagnosis apparatus 100 according to the present embodiment configured as described above makes it possible to improve visibility of a lesion site. More specifically, the X-ray diagnosis apparatus 100 makes it possible to improve visibility of a lesion site when an X-ray image is displayed with improved visibility of a treatment tool (a device) during an endovascular intervention treatment that is performed while the medical provider is referring to an X-ray image.

For example, when performing an endovascular intervention treatment on a cardiovascular stenosis site of the subject P by using “a catheter with a balloon having a stent”, a medical doctor determines the position of the device by referring to an X-ray image generated and displayed by an X-ray diagnosis apparatus. In this situation, as explained above, when an endovascular intervention treatment is performed on a blood vessel in an organ constantly having a pulsating motion such as the heart or in an organ moving due to the pulsating motion, the position of the device in the X-ray image moves. Thus, determining the position of the device while referring to the X-ray image requires an extremely high level of skills of the medical doctor.

To cope with this situation, for example, the X-ray diagnosis apparatus 100 displays a moving picture in which the device virtually appears to be stationary, by tracking markers at two points that are rendered in sequentially-generated X-ray images and deforming the images in such a manner that the positions of the markers at the two points in the X-ray images are in the same positions as those in a past image. For example, the X-ray tube 12 radiates X-rays onto a region of interest (e.g., the heart) of the subject P, so that the X-ray detector 16 sequentially detects X-rays that have passed through the region of interest. On the basis of pieces of data successively detected by the X-ray detector 16, the X-ray diagnosis apparatus 100 performs an image processing process so that the device included in the X-ray images sequentially generated in a time series virtually appears to be stationary and displays the images as a moving picture in a real-time manner.

With this arrangement, the X-ray diagnosis apparatus 100 is able to display the X-ray images with improved visibility of the device, the X-ray images being displayed during the endovascular intervention treatment performed while the medical provider is referring to the X-ray images. The X-ray diagnosis apparatus 100 thus makes it possible to easily determine the position of the device. According to the technique described above, however, visibility of the lesion site may be degraded in some situations. To cope with these situations, the X-ray diagnosis apparatus 100 of the present disclosure makes it possible to improve the visibility of the lesion site while the processing circuitry 21 explained in detail below displays the moving picture in which the device virtually appears to be stationary.

In the following sections, first, a process of displaying the moving picture in which the device virtually appears to be stationary will be explained. In the following sections, an example will be explained in which the process is performed as a result of the processing circuitry 21 controlling the image processing circuitry 26 by executing the various types of functions. However, another arrangement is also acceptable in which the processing circuitry 21 performs the same processes as those performed by the image processing circuitry 26.

The detecting function 211 is configured, by controlling the image processing circuitry 26, to identify an object related to a medical device inserted in the body of the subject P, by using a group of pieces of image data sequentially generated by the image data generating circuitry 24 during a predetermined time period and to detect the position of the object in a newly-generated X-ray image on the basis of the identified result. In other words, the detecting function 211 controls the image processing circuitry 26 so as to detect the object included in the X-ray images generated from the image data. Here, the predetermined time period for detecting the object and the object to be detected may determine until the detecting process is stated. For example, the predetermined time period for detecting the object and the object are determined before the generation of the image data, during the generation of the image data or after the generation of the image data. For example, every time a new image (i.e., a new X-ray image) is stored, the detecting function 211 detects coordinates of stent markers attached to a stent or a point (e.g., a middle point) based on the stent markers, within the new image. In other words, the detecting function 211 detects the positions of the stent markers within each of the sequentially-generated X-ray images, on the basis of information about the stent markers rendered in the images. In one example, the detecting function 211 detects either the positions of the stent markers or the position of the one point (e.g., the middle point) based on the stent markers, in each of the sequentially-generated X-ray images, on the basis of the information about the stent markers designated by an operator or a teacher image of the stent markers.

In this situation, the detecting function 211 generates an enhanced image in which the object is enhanced from each of the sequentially-generated X-ray images and further detects the position of the object included in each of the plurality of generated enhanced images. More specifically, the detecting function 211 generates the enhanced images each of which is either a frequency image including a predetermined frequency component or an image including a predetermined brightness value and further detects the position of the object included in each of the generated enhanced images. In other words, each of the enhanced images is generated by performing a process of extracting the predetermined frequency component or performing a process of converting pixel value for extracting a pixel having the predetermined brightness value. In the following sections, an example will be explained in which the detecting function 211 generates frequency images. Here, the predetermined frequency component and the predetermined brightness value may determine until the detecting process is stated. For example, the predetermined frequency component and the predetermined brightness value are determined before the generation of the image data, during the generation of the image data or after the generation of the image data.

For example, the detecting function 211 generates a frequency image including the predetermined frequency component from each of the sequentially-generated X-ray images and further detects the position of the object included in each of the plurality of generated frequency images. In one example, the detecting function 211 generates a high-frequency image including a high-frequency component from each of the sequentially-generated X-ray images and further detects the coordinates of either the stent markers or one point based on the state markers within each of the generated high-frequency images. In other words, the predetermined frequency component is a frequency component including a component corresponding to the object. The detecting function 211 detects the position of the object by generating the frequency images in each of which the object is enhanced.

For example, by performing a smoothing process on the X-ray images, the detecting function 211 generates a low-frequency image of each of the X-ray images. Further, by subtracting the low-frequency images from the X-ray images, the detecting function 211 generates the high-frequency images obtained by eliminating low-frequency components from the X-ray images. Further, the detecting function 211 detects the coordinates of either the stent markers or one point based on the stent markers within each of the generated high-frequency images. For example, by performing the process described above on each of the sequentially-generated X-ray images, the detecting function 211 generates a high-frequency image from each of the X-ray images and further detects the coordinates of either the stent markers or the one point based on the stent markers included in each of the generated high-frequency images. In this situation, the high-frequency images do not necessarily have to be generated by using the method described above and may be generated by using any other arbitrary method such as by performing a process that uses a band-pass filter, for example.

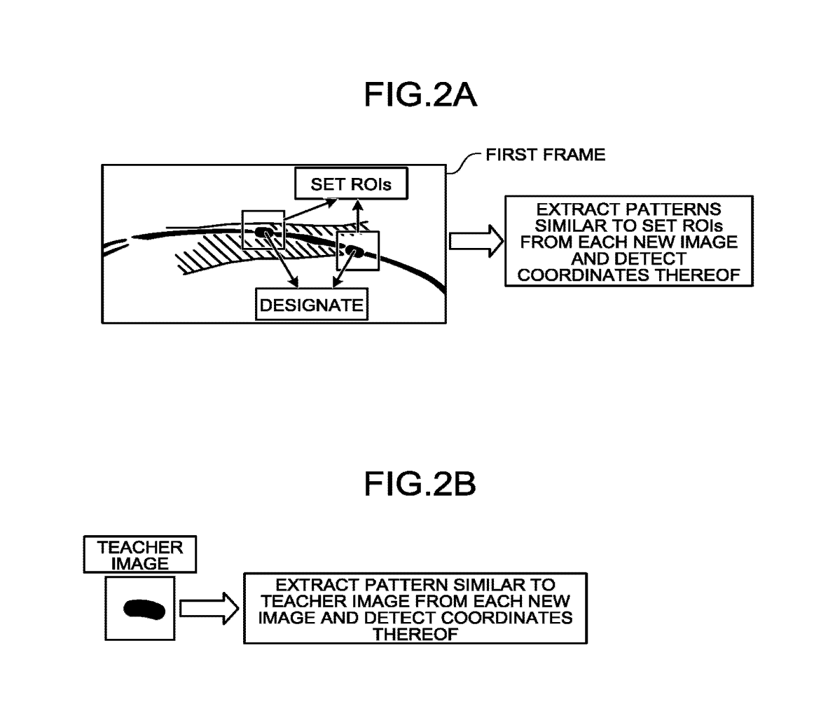

Next, a process of displaying the moving picture in which the device virtually appears to be stationary will be explained, while using an example in which the positions of two stent markers are detected. In the following sections, a process performed after the high-frequency images are generated will be explained. FIGS. 2A and 2B are drawings for explaining a process performed by the detecting function 211 according to the first embodiment. For example, as illustrated in FIG. 2A, the display controlling function 214 (explained later) exercises control so that the display 23 displays an X-ray image (a first frame) that was generated first and stored in the storage circuitry 25. An operator (e.g., a medical doctor) who refers to the first frame designates two stent markers within the first frame via the input circuitry 22, as illustrated in FIG. 2A. Accordingly, the detecting function 211 detects the coordinates of each of the two stent markers within the first frame.

After that, as illustrated in FIG. 2A, the detecting function 211 sets, as Regions Of Interest (ROIs), rectangles each centered on the coordinates of a different one of the two stent markers designated in the first frame. Further, from each of new images that are sequentially generated, the detecting function 211 extracts a pattern similar to the pattern within each of the set ROIs by implementing a cross correlation method, for example, and detects such coordinates that have a largest cross-correlational value, as the coordinates of each of the stent markers.

In this situation, although FIG. 2A illustrates the example in which the operator designates the stent markers in the two locations, the present embodiment is not limited to this example. The operator may designate a stent marker in one location. In that situation, within the first frame also, the detecting function 211 detects the coordinates of another stent marker by implementing a cross correlation method while using a ROI set on the basis of the coordinates of the designated stent marker.

Alternatively, the detecting function 211 may detect the coordinates of a stent marker by using a teacher image indicating shape and brightness characteristics of the stent marker within X-ray images, the stent marker being attached to a stent used in an actual treatment. For example, as illustrated in FIG. 2B, an X-ray image of the stent marker is stored separately as a teacher image. The detecting function 211 extracts a pattern similar to the pattern in the teacher image from each new image and further detects the coordinates of the stent marker by searching for a region having the highest degree of similarity from among extracted stent marker candidate regions.

In this situation, to detect the coordinates of the stent markers from each of the sequentially-generated X-ray images, the detecting function 211, at first, identifies (specifies) the stent markers by using the plurality of X-ray images. In other words, the detecting function 211 identifies the object inserted in the body of the subject P and rendered in the X-ray images, by using the group of sequentially-generated X-ray images and further detects the position of the object included in a newly-generated X-ray image on the basis of the identified result. For example, the detecting function 211 extracts all the regions similar to the stent markers from each of a plurality of X-ray images corresponding to a predetermined time period, by using either the stent markers designated by the operator or the stent marker based on the teacher image. After that, the detecting function 211 extracts, from the regions extracted from each of the plurality of X-ray images, such regions that most likely represent the stent markers from a comprehensive judgment, as the stent markers. In the following sections, the process of detecting and identifying (specifying) the stent markers described above will be referred to as a “Learning Mode”.

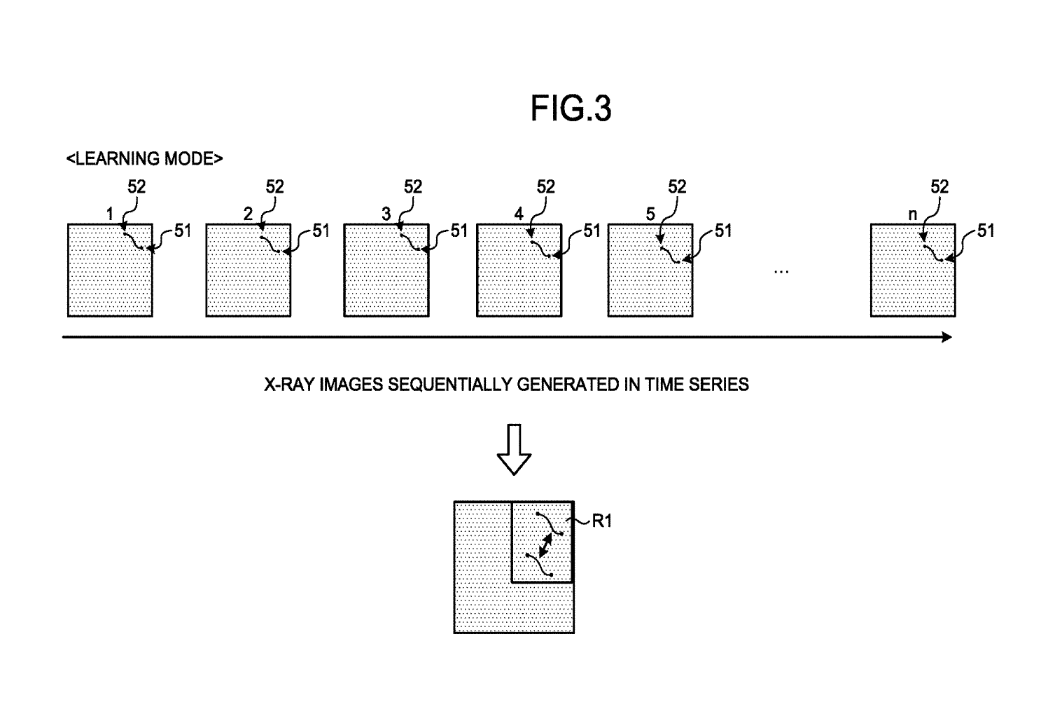

FIG. 3 is a drawing for explaining an example of the Learning Mode according to the first embodiment. FIG. 3 illustrates the Learning Mode that uses X-ray images in n frames generated by the image processing circuitry 26. For example, the detecting function 211 extracts all the regions (coordinates) similar to the stent markers from the entire region of the first frame illustrated in FIG. 3. Further, the detecting function 211 organizes all the extracted coordinates into pairs and further calculates an evaluation score of each of the pairs on the basis of a degree of similarity or the like. For example, the detecting function 211 assigns an evaluation score to a pair made up of coordinates 51 and coordinates 52. Although the example in FIG. 3 illustrates only the coordinates 51 and the coordinates 52, if regions (coordinates) similar to the stent markers are included, such coordinates are also detected. An evaluation score is assigned by organizing the detected coordinates with the coordinates 51, the coordinates 52, or another set of coordinates into a pair.

Similarly, the detecting function 211 performs the abovementioned process on each of the frames from the second to the n-th frames and assigns an evaluation score to each of the pairs based on all the extracted coordinates. Further, the detecting function 211 extracts the coordinates of such a pair that has the highest evaluation score in each of the frames as the coordinates of the stent markers and further extracts a region including positions in which the stent markers can possibly be present, within the X-ray images corresponding to the predetermined time period. For example, as illustrated in FIG. 3, the detecting function 211 extracts the pair made up of the coordinates 51 and the coordinates 52 having the highest evaluation score from each of the frames and further extracts a region R1 including the two sets of coordinates. To extract the region R1, for example, a rectangle centered on the coordinates of the middle point between the coordinates 51 and the coordinates 52 is extracted from each of the frames, so as to extract such a region including all the extracted rectangles as the region R1.

For example, because the pulsating motion of the heart and the expansion and contraction of the lungs are regular (periodic), stent markers moving therewith exhibit a regular (periodic) movement. In the Learning Mode described above, the stent markers exhibiting a regular (periodic) movement are detected in an exhaustive manner by using the X-ray images corresponding to the predetermined time period so as to identify (specify) objects that most likely represent the stent markers as the stent markers. In the Learning Mode, X-ray images in approximately forty frames are used, for example.

As described above, in the Learning Mode, the detecting function 211 first identifies (specifies) the stent markers within the X-ray images and extracts the region including the positions in which the stent markers can possibly be present. After that, the detecting function 211 detects the stent markers while using the extracted region as a target region. For example, by using the region R1 illustrated in FIG. 3 as a processing target region, the detecting function 211 performs the stent marker detecting process.

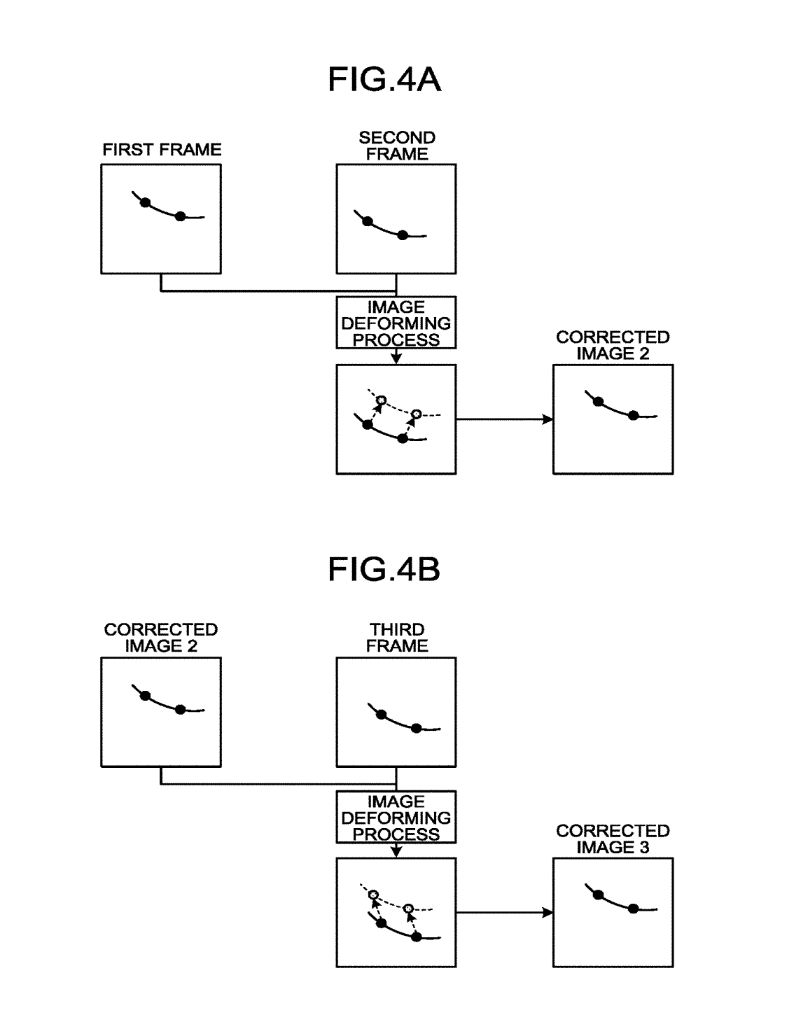

By controlling the image processing circuitry 26, the corrected image generating function 213 is configured to generate a corrected image from a new image by performing an image moving process such as a parallel translation or a rotational move and/or an image deforming process such as an affine transformation, in such a manner that, while using the coordinates of the stent markers already detected by the detecting function 211 as reference coordinates, the coordinates of the stent markers detected from the new image by the detecting function 211 match the reference coordinates. FIGS. 4A and 4B are drawings for explaining the process performed by the corrected image generating function 213 according to the first embodiment. FIGS. 4A and 4B illustrate the process performed on a new image from which the coordinates of the stent markers have been detected on the basis of a processing result in the Learning Mode, after the process in the Learning Mode performed by the detecting function 211 is finished. In other words, the first frame illustrated in FIGS. 4A and 4B denotes the X-ray image generated first, after the Learning Mode is finished.

For example, at first, the detecting function 211 performs the process in the Learning Mode by using the images in the forty frames. With respect to the first frame and the second frame generated after the Learning Mode is finished, the detecting function 211 detects the coordinates of the stent markers by using the processing result in the Learning Mode, as illustrated in FIG. 4A. When the detecting function 211 has detected the coordinates of the stent markers, the corrected image generating function 213 generates corrected image 2 from the second frame by performing an image deforming process, in such a manner that, as illustrated in FIG. 4A, the coordinates of the stent markers detected from the X-ray image in the second frame generated as a new image match the coordinates (the reference positions) of the stent markers already detected from the first frame. After that, with respect to each of the new images in the third frame and thereafter, the corrected image generating function 213 generates a corrected image while using, as reference coordinates, the coordinates of the stent markers in the corrected image generated thereby from the X-ray image generated immediately prior to the new image. For example, as illustrated in FIG. 4B, the corrected image generating function 213 generates corrected image 3 from the third frame by performing an image deforming process, in such a manner that the coordinates of the stent markers detected from the third frame matches the coordinates of the stent markers in corrected image 2 generated from the second frame.

In the first embodiment, the example is explained in which the coordinates of the stent markers in the corrected image generated from the immediately preceding frame of a new image are used as the reference coordinates; however, possible embodiments are not limited to this example. It is also acceptable to generate a corrected image from a new image in the second frame and thereafter, by using the coordinates of the stent markers detected from the first frame as the reference coordinates in a fixed manner. It should be noted that, however, because the corrected images are used for generating display-purpose images that are used for displaying a moving picture, as explained below, it is desirable to generate each corrected image from a new image by using an immediately preceding corrected image, for the purpose of displaying, without fail, images in which the positions of the stent markers do not move around, as a moving picture.

As explained above, the corrected image generating function 213 generates the corrected images by arranging the coordinates of the stent markers detected by the detecting function 211 to match one another among the images. In other words, after the stent markers are identified in the Learning Mode, the corrected image generating function 213 generates the corrected images by arranging the coordinates of the stent markers detected from the following X-ray images to match one another among the images, while using the processing result from the Learning Mode. In the explanation below, the process described above of generating the corrected images will be referred to as a “Tracking Mode”.

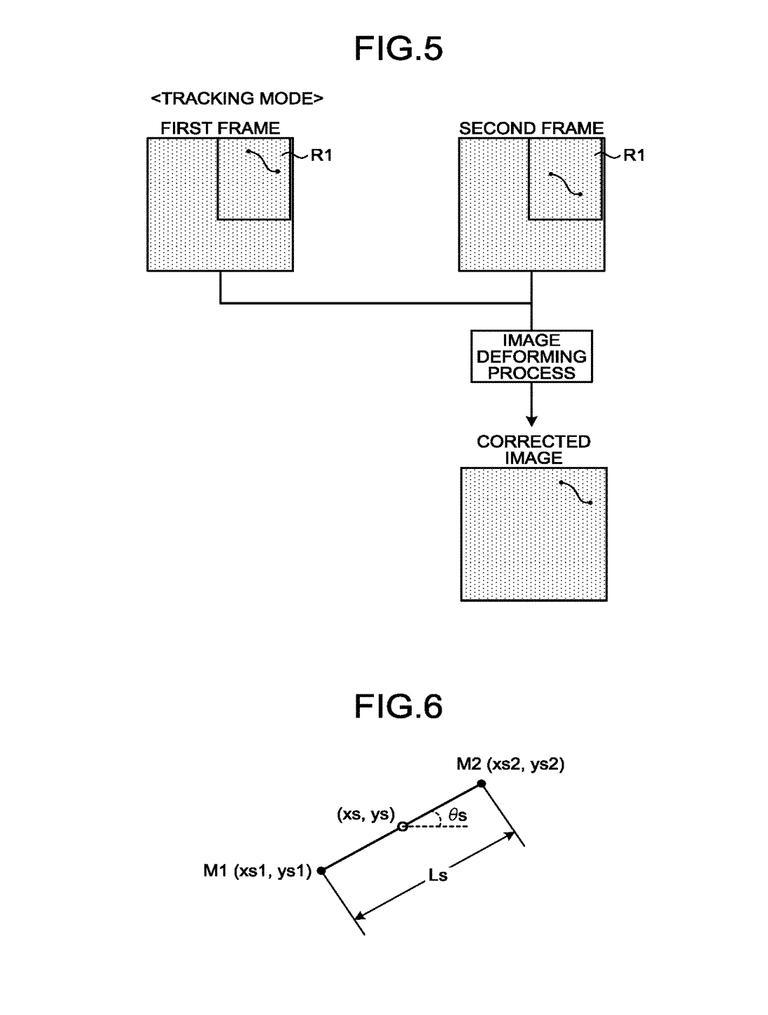

FIG. 5 is a drawing for explaining an example of the Tracking Mode according to the first embodiment. For example, in the Tracking Mode, as illustrated in FIG. 5, a corrected image is generated by performing an image deforming process in such a manner that the positions of the stent markers detected from the region R1 extracted in the Learning Mode match each other. In other words, the corrected image generating function 213 generates the corrected image while targeting the X-ray image from which the stent markers were detected by the detecting function 211 after the Learning Mode.

The display controlling function 214 is configured to cause the display 23 to display, as a moving picture, the corrected images generated by the corrected image generating function 213. More specifically, the display controlling function 214 exercises control so that, every time a corrected image is newly generated in a time series, the display 23 sequentially displays the newly-generated corrected image as a display-purpose image. In other words, the display controlling function 214 exercises control so that the display-purpose images in which the coordinates of the stent markers match one another, as the moving picture. As a result, for example, it is possible to display, as the moving picture, the X-ray images in which the parts exhibiting the stent do not move around, although the background parts other than the stent may seem to be moving around.

In this situation, by controlling the image processing circuitry 26, the display controlling function 214 is also capable of exercising control so that display-purpose images are displayed as a moving picture, the display-purpose images being obtained by performing any of various types of filtering process on the corrected images. For example, the display controlling function 214 is capable of generating display-purpose images by controlling the image processing circuitry 26 so as to perform a high-frequency noise-reducing filtering process on the corrected images by using a recursive filter. The recursive filter is a filter configured to reduce high-frequency noise by adding the pixel values of pixels constituting a frame in the past to which a predetermined weight has been applied, to the pixel values of pixels constituting a frame serving as a processing target. Because the coordinates of the stent markers match one another among the corrected images, it is also possible to improve the visibility of the stent in the corrected images by reducing the high-frequency noise in the stent parts while using the recursive filter that uses the frame in the past. Here, the predetermined weight may determine until the filtering process is stated. For example, the predetermined weight is determined before the generation of the corrected images, during the generation of the corrected images or after the generation of the corrected images.

In other words, the display controlling function 214 causes the display-purpose images to be generated and displayed as the moving picture, the display-purpose images having the improve visibility of the device as a result of sequentially performing the recursive filtering process that uses the corrected image in the past, on the sequentially-generated corrected images. In addition, the display controlling function 214 is also capable of causing display-purpose images to be generated by simply adding together the sequentially-generated corrected images.

The process to display the moving picture in which the device virtually appears to be stationary has thus been explained. In the description above, the example is explained in which the image deforming process is performed in such a manner that the positions of the two stent markers in the newly-generated X-ray image match the positions of the two stent markers in the X-ray image in the first frame. However, possible embodiments are not limited to this example. Another arrangement is also acceptable in which a corrected image is generated by using a single point based on the two stent markers. In other words, the detecting function 211 identifies a position (coordinates) by performing the process in the Learning Mode on a single point based on the two stent markers (e.g., the middle point between the two stent markers) and further detects the single point based on the stent markers within a new image on the basis of the processing result. The corrected image generating function 213 generates corrected images by making corrections in such a manner that the detected single points based on the stent markers match one another.

In that situation, the corrected image generating function 213 uses the single point and an angle defined by a feature pattern detected from an X-ray image (e.g., the first frame) set as a reference image. After that, the corrected image generating function 213 generates a corrected image from a target image being the X-ray image to be corrected, on the basis of the feature pattern detected from the target image, the predetermined single point, and the predetermined angle. After that, the display controlling function 214 causes the display 23 to display, as a moving picture, the corrected images sequentially generated by the corrected image generating function 213. Here, the predetermined single point and the predetermined angle may determine until the process of generating the corrected image is stated. For example, the predetermined single point and the predetermined angle are determined before the generation of the image data, during the generation of the image data or after the generation of the image data.

The following sections will describe an example of the process (a single-point fixation process) to display a moving picture in which the device virtually appears to be stationary by using a single point within X-ray images. In the present example, a situation will be explained in which a treatment tool has two feature points (e.g., two stent markers). In that situation, the detecting function 211 detects the two feature points of the device as feature patterns. After that, the corrected image generating function 213 uses a single point defined by the positions of the two feature points detected from a reference image as the predetermined single point. Further, the corrected image generating function 213 uses the angle formed by a line segment connecting together the two feature points detected from the reference image and a reference line in the reference image, as the predetermined angle.

FIG. 6 is a drawing for explaining the single-point fixation process according to the first embodiment. For example, the detecting function 211 detects the position (the coordinates) of each of two markers (M1 and M2) from the X-ray image in the first frame set as a reference image. In one example, as illustrated in FIG. 6, the detecting function 211 detects “(xs1,ys1) and (xs2,ys2)” as the positions of M1 and M2. On the basis of the detection result obtained by the detecting function 211, the corrected image generating function 213 determines the “position (coordinates) of a single point” to be used in an image deforming process. For example, as illustrated in FIG. 6, the corrected image generating function 213 calculates the coordinates of the center “(xs,ys)” between M1 and M2. The coordinates of the center represents the middle point of the line segment (hereinafter, “line segment M1&2”) connecting M1 and M2 together. In other words, “xs” can be expressed as “(xs1+xs2)/2”, whereas “ys” can be expressed as “(ys1+ys2)/2”. Further, as illustrated in FIG. 6, for example, the corrected image generating function 213 calculates an angle “θs” formed by the line segment M1&2 and a reference line indicating the horizontal direction of the reference image.

As a result, the “single point and angle” to be used in the image deforming process are defined. After that, the detecting function 211 detects the positions (the coordinates) of M1 and M2 in the X-ray image to be corrected (the target image) generated after the reference image. Further, the corrected image generating function 213 performs the image deforming process on the target image in such a manner that the position (the coordinates) of the middle point of the line segment M1&2 in the target image is equal to (xs,ys), while the angle formed by the line segment M1&2 and the reference line is equal to “θs”. In other words, in the single-point fixation process, the image deforming process is performed on the target image in such a manner that the device rendered in the corrected images goes through mutually-the-same single point, while the inclinations of the device rendered in the corrected images are at mutually-the-same angle. After that, the display controlling function 214 causes the display 23 to display, as a moving picture, the corrected images sequentially generated by the corrected image generating function 213.

The process to display the moving picture in which the device virtually appears to be stationary has thus been explained. The X-ray diagnosis apparatus 100 of the present disclosure improves the visibility of the lesion site, when displaying the moving picture in which the device virtually appears to be stationary as described above. As explained above, when the moving picture is displayed in which the device is virtually arranged to be stationary, the corrected image generating function 213 generates the corrected images of the X-ray images from which the stent markers were detected by the detecting function 211. In other words, the corrected image generating function 213 generates the corrected images by performing the image deforming processes on the high-frequency images from which the stent markers were detected by the detecting function 211. In that situation, the corrected images generated by the corrected image generating function 213 are images including none of the low-frequency components that are included in the X-ray images. Accordingly, the corrected images may be, in some situations, images rendering no lesion site represented by a calcified site (calcium), for example.

To cope with these situations, the X-ray diagnosis apparatus 100 according to the first embodiment generates corrected images in which it is possible to view a lesion site represented by a calcified site or the like, even when a moving picture in which the device is virtually arranged to be stationary is displayed. More specifically, while using the position of an object detected from a reference image included in a plurality of frequency images as a reference position, the determining function 212 determines processing details of a correcting process performed to arrange the position of the object detected from a newly-generated frequency image to match the reference position. In other words, the determining function 212 determines the processing details of an image deforming process performed to virtually arrange the device to be stationary, on the basis of either the position of the stent markers detected from high-frequency images by the detecting function 211 or the position of a single point based on the positions of the stent markers.

The corrected image generating function 213 sequentially generates corrected images by performing the correcting processes according to the processing details determined by the determining function 212 on the X-ray images from each of which a newly-generated frequency image was generated. In other words, the corrected image generating function 213 generates the corrected images by performing the image deforming processes determined by the determining function 212 on the original X-ray images from each of which a high-frequency image was generated.

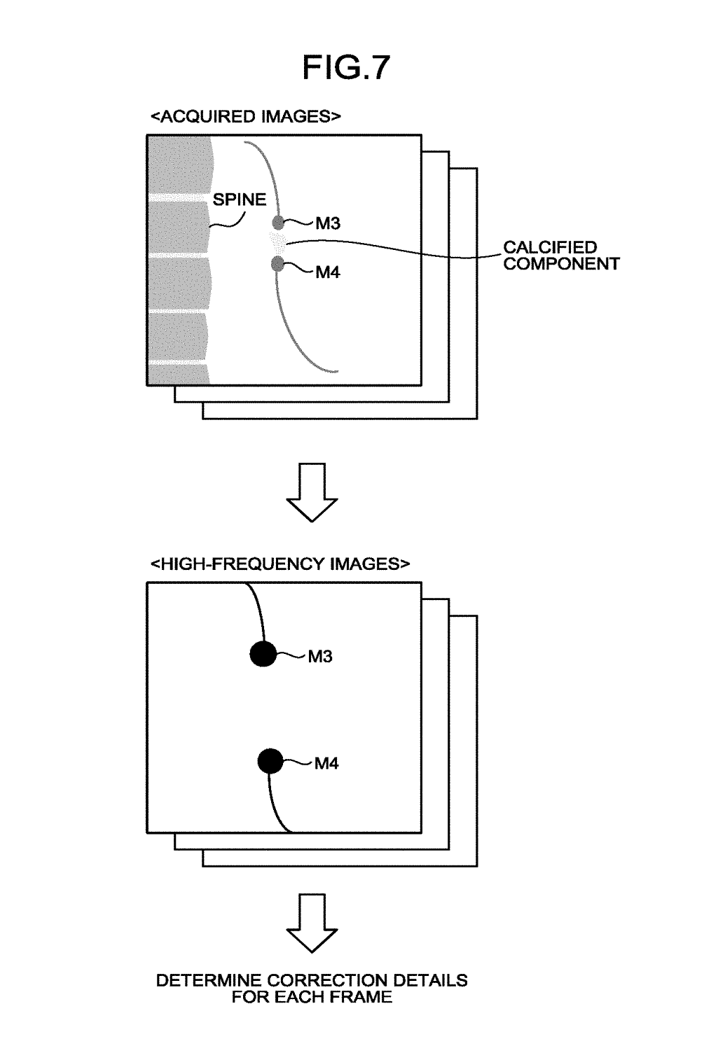

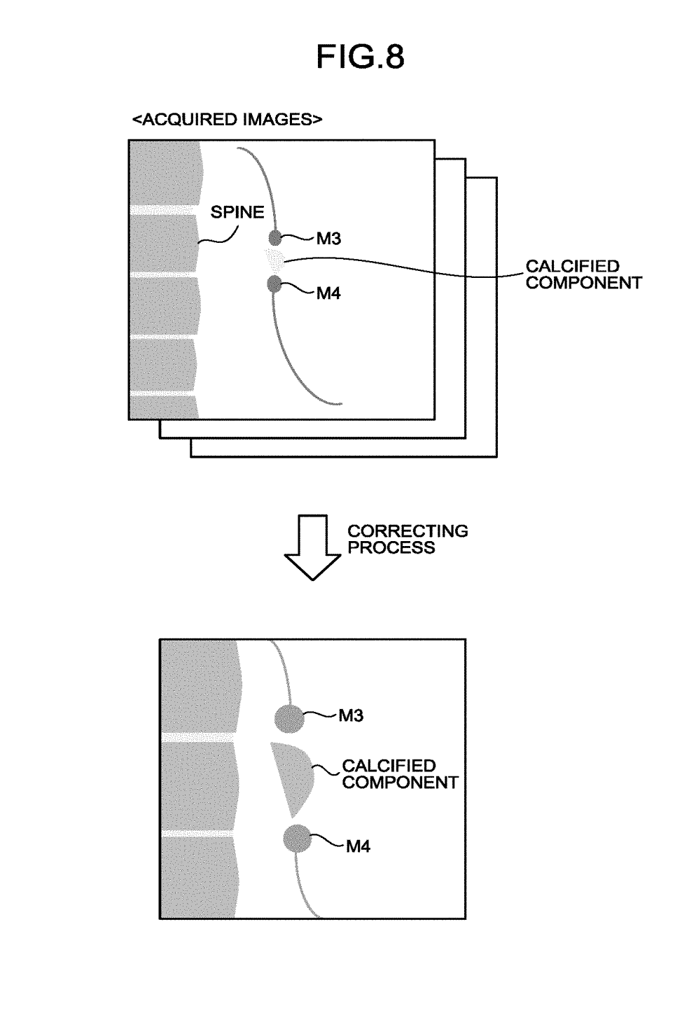

Next, an example of a process performed by the determining function 212 and the corrected image generating function 213 according to the first embodiment will be explained, with reference to FIGS. 7 and 8. FIG. 7 is a drawing for explaining an example of a process performed by the determining function 212 according to the first embodiment. FIG. 8 is a drawing for explaining an example of a process performed by the corrected image generating function 213 according to the first embodiment. In the X-ray diagnosis apparatus 100 according to the first embodiment, for example, as illustrated in FIG. 7, the detecting function 211 generates a high-frequency image from each of a plurality of X-ray images (the acquired images in FIG. 7) acquired chronologically and further detects the positions (the coordinates) of markers M3 and M4 in each of the generated high-frequency images. In other words, the detecting function 211 generates the high-frequency image from each of the X-ray images taken in the time series and further detects the positions of the markers M3 and M4 from each of the generated high-frequency images.

In this situation, the high-frequency images generated under the control of the detecting function 211 are images in which, in comparison to the acquired images, the marker M3 and the marker M4 are enhanced, while components of the spine and a calcified component that are not included in the high-frequency components are eliminated, as illustrated in FIG. 7. As a result, the detecting function 211 is able to detect the markers with a higher level of precision. However, when corrected images are generated as display-purpose images by performing image deforming processes on these high-frequency images, it is impossible to view a lesion site represented by a calcified component and the like.

To cope with this situation, the determining function 212 determines, as illustrated in FIG. 7, details of a correcting process (hereinafter, “correction details”) to be performed on each of the frames from which the marker M3 and the marker M4 were detected. In other words, while using the coordinates of the marker M3 and the marker M4 already detected by the detecting function 211 as reference coordinates, the determining function 212 determines processing details of an image deforming process to arrange the coordinates of the marker M3 and the marker M4 detected from a new image by the detecting function 211 to match the reference coordinates. The determining function 212 determines processing details of an image deforming process to be performed, with respect to each of the newly-generated high-frequency images.

As illustrated in FIG. 8, for example, the corrected image generating function 213 generates a corrected image by performing the image deforming process determined by the determining function 212 on the original X-ray images (the acquired images) from each of which a high-frequency image was generated. In other words, with respect to each of the frames in the acquired images, the corrected image generating function 213 generates a corrected image to be used when displaying a moving picture in which the device virtually appears to be stationary, by performing the correcting process according to the details determined by using the corresponding high-frequency image.

The display controlling function 214 causes the display 23 to display, as the moving picture, the corrected images generated by the corrected image generating function 213 from the X-ray images. In this situation, when displaying the corrected images sequentially generated by performing the abovementioned process as the moving picture, the display controlling function 214 is capable of causing display-purpose images to be displayed on which an adding process that uses a recursive filter or the like has been performed. As a result, for example, the viewer is able to view the moving picture rendering the components of the spine and the calcified component, as illustrated in FIG. 8. In this situation, in the moving picture in which the marker M3 and the marker M4 are virtually arranged to be stationary, the calcified component positioned between the markers are also viewed as being stationary. In other words, the viewer is able to view the moving picture in which the device and the lesion site are virtually stationary.

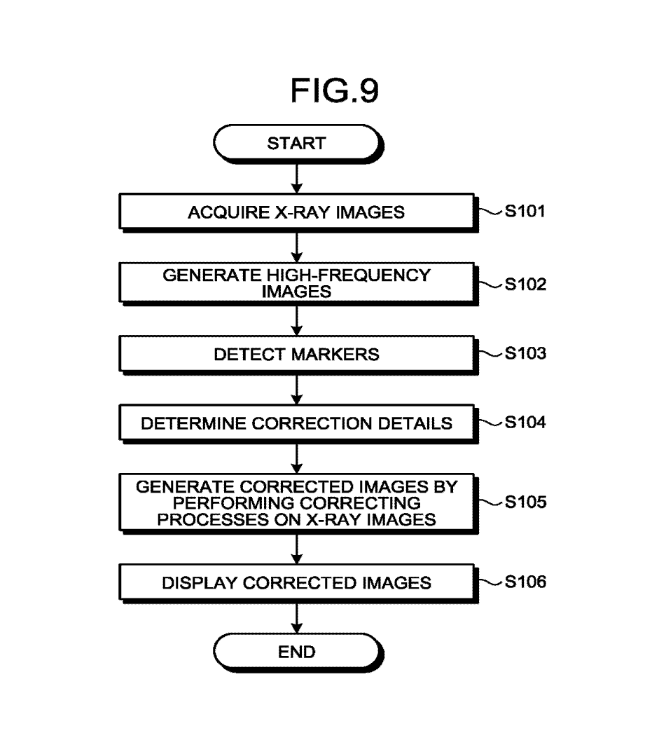

Next, a process performed by the X-ray diagnosis apparatus 100 according to the first embodiment will be explained, with reference to FIG. 9. FIG. 9 is a flowchart illustrating a processing procedure performed by the X-ray diagnosis apparatus 100 according to the first embodiment. In FIG. 9, step S101 is a step at which the processing circuitry 21 reads and executes the program corresponding to the controlling function from the storage circuitry 25. Further, steps S102 and S103 are steps at which the processing circuitry 21 reads and executes the program corresponding to the detecting function 211 from the storage circuitry 25. Step S104 is a step at which the processing circuitry 21 reads and executes the program corresponding to the determining function 212 from the storage circuitry 25. Further, step S105 is a step at which the processing circuitry 21 reads and executes the program corresponding to the corrected image generating function 213 from the storage circuitry 25. Step S106 is a step at which the processing circuitry 21 reads and executes the program corresponding to the display controlling function 214 from the storage circuitry 25.

At step S101, the processing circuitry 21 acquires X-ray images. At steps S102 and S103, the processing circuitry 21 generates a high-frequency image from each of the acquired X-ray images and further detects the markers included in each of the high-frequency images. At step S104, on the basis of the positions of the markers detected by using the high-frequency images, the processing circuitry 21 determines correction details of correcting processes to perform image deforming processes on the X-ray images.

At step S105, the processing circuitry 21 generates corrected images by performing the correcting processes determined by using the high-frequency images, on the X-ray images. At step S106, the processing circuitry 21 causes the display 23 to display the generated corrected images as a moving picture.

As explained above, according to the first embodiment, the detecting function 211 is configured to generate the frequency image including the predetermined frequency component from each of the sequentially-generated X-ray images and to further detect the position of the object included in each of the plurality of generated frequency images. While using the position of the object detected from the reference image included in the plurality of frequency images as the reference position, the determining function 212 is configured to determine the processing details of the correcting process performed to arrange the position of the object detected from the newly-generated frequency image to match the reference position. With respect to the X-ray images from each of which a newly-generated frequency image was generated, the corrected image generating function 213 is configured to sequentially generate corrected images by performing the correcting processes according to the processing details determined by the determining function 212. The display controlling function 214 is configured to cause the display 23 to display the corrected images sequentially generated by the corrected image generating function 213 as the moving picture. Accordingly, the x-ray diagnosis apparatus 100 according to the first embodiment is able to display the moving picture in which the device virtually appears to be stationary, by using the X-ray images rendering the lesion site. The X-ray diagnosis apparatus 100 thus makes it possible to improve the visibility of the lesion site.

Further, according to the first embodiment, the predetermined frequency component is a frequency component including the component corresponding to the object. The frequency image is an image in which the object is enhanced. Accordingly, even when displaying the moving picture in which the device virtually appears to be stationary by using the X-ray images rendering the lesion site, the X-ray diagnosis apparatus 100 according to the first embodiment makes it possible to prevent degradation of the level of precision in detecting the markers or the like.

### Second Embodiment

In the first embodiment described above, the example is explained in which the corrected images are generated by determining the correction details on the basis of the positions of the markers detected by using the high-frequency images and further performing the correcting processes on the X-ray images. In a second embodiment, an example will be explained in which corrected images are generated by performing correcting processes on the high-frequency images and on the X-ray images. The X-ray diagnosis apparatus 100 according to the second embodiment is different from that in the first embodiment for the contents of the process performed by the corrected image generating function 213. In the following sections, the second embodiment will be explained while a focus is placed on the difference.

The corrected image generating function 213 according to the second embodiment is configured to sequentially generate corrected images each obtained by combining a first partial image resulting from a correcting process according to processing details determined by the determining function 212 performed on a predetermined region within an X-ray image from which a newly-generated frequency image was generated, with a second partial image resulting from a correcting process according to the processing details determined by the determining function 212 performed on a region different from the predetermined region within the newly-generated frequency image. In other words, the corrected image generating function 213 generates a first partial corrected image by performing the correcting process determined by the determining function 212 on the predetermined region within the X-ray image. Further, the corrected image generating function 213 generates a second partial corrected image by performing the correcting process determined by the determining function 212 on the region other than the predetermined region within the high-frequency image. After that, the corrected image generating function 213 generates the corrected image by combining the generated first partial corrected image with the generated second partial corrected image. Here, the predetermined region may determine until the process of generating the corrected image is stated. For example, the predetermined region is determined during the generation of the image data or after the generation of the image data.

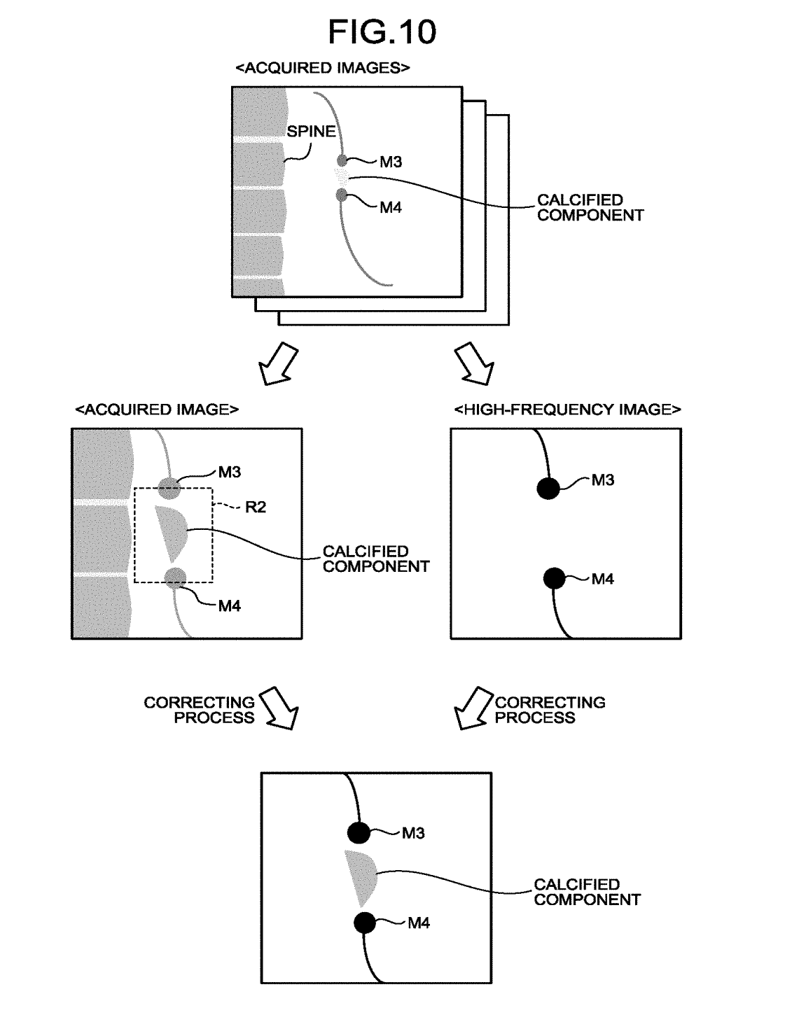

FIG. 10 is a drawing for explaining an example of a process performed by the corrected image generating function 213 according to the second embodiment. In the X-ray diagnosis apparatus 100 according to the second embodiment, the detecting function 211 first generates a high-frequency image from each of the plurality of X-ray images (the acquired images in FIG. 10) acquired chronologically and further detects the positions (the coordinates) of the markers M3 and M4 in each of the generated high-frequency images, in the same manner as in the first embodiment. After that, in the same manner as in the first embodiment, the determining function 212 determines correction details with respect to each of the frames from which the marker M3 and the marker M4 were detected. In other words, while using the coordinates of the marker M3 and the marker M4 already detected by the detecting function 211 as reference coordinates, the determining function 212 determines the processing details of the image deforming process to arrange the coordinates of the marker M3 and the marker M4 detected from a new image by the detecting function 211 to match the reference coordinates.

For example, as illustrated in FIG. 10, the corrected image generating function 213 generates a first partial corrected image by performing the image deforming process determined by the determining function 212 on a region R2 of the original X-ray image (the acquired image) from which the high-frequency image was generated. In this situation, the predetermined region in which the first partial corrected image is generated may arbitrarily be set by the operator. For example, the display controlling function 214 causes the display 23 to display the acquired image, so that the operator sets the predetermined region via the input circuitry 22 while viewing the acquired image displayed on the display 23. In this situation, as illustrated in FIG. 10, for example, the operator sets the region R2 including a lesion site represented by a calcified component or the like as the predetermined region.

Alternatively, the predetermined region may be set automatically. In that situation, for example, the corrected image generating function 213 sets a region including a region positioned between two or more objects, as the predetermined region. For example, the corrected image generating function 213 sets a region positioned between the marker M3 and the marker M4 as the predetermined region. In this situation, because lesion sites represented by a calcified component or the like are often positioned between markers, the lesion site will be included in the predetermined region even when the region positioned between the markers is set as the predetermined region. The shape and the size of the region may arbitrarily be set, when the predetermined region is automatically set.

When the region R2 has been set within the X-ray image either manually or automatically as explained above, the corrected image generating function 213 generates the first partial corrected image obtained by correcting the region R2 in the X-ray image, by performing the correcting process determined by the determining function 212 on the region R2 within the X-ray image. Further, by performing the correcting process determined by the determining function 212 on the region other than the region R2 within the high-frequency image, the corrected image generating function 213 generates a second partial corrected image obtained by correcting the region other than the region R2 within the high-frequency image. After that, by combining the generated first partial corrected image with the generated second partial corrected image, the corrected image generating function 213 generates a corrected image as illustrated in FIG. 10, for example.

In other words, as illustrated in FIG. 10, the corrected image generating function 213 generates the corrected image in which the marker M3 and the marker M4 are enhanced, while the calcified component included in the region R2 is rendered. The corrected image generating function 213 sequentially generates corrected images by performing the abovementioned process on each of the acquired frames. The display controlling function 214 causes the sequentially-generated corrected images to be displayed as a moving picture. When causing the sequentially-generated corrected image to be displayed as the moving picture by performing the process described above, the display controlling function 214 is capable of causing display-purpose images to be displayed on which an adding process that uses a recursive filter or the like has been performed. As a result, the viewer is able to view the moving picture in which the device is enhanced, and also, the calcified component is rendered.

In the example above, the example is explained in which each of the corrected images is generated by combining the region R2 in the X-ray image with the partial corrected image generated by performing the image deforming process on the region other than the region R2 within the high-frequency image. However, possible embodiments are not limited to this example. For instance, it is also acceptable to perform an image deforming process on the entirety of each of the images and to superimpose the image in the region R2 within the X-ray images onto the high-frequency images. Alternatively, it is also acceptable to perform an image deforming process on the region R2 within the X-ray images and the entirety of the high-frequency images and to superimpose the images in the region R2 onto the high-frequency images.

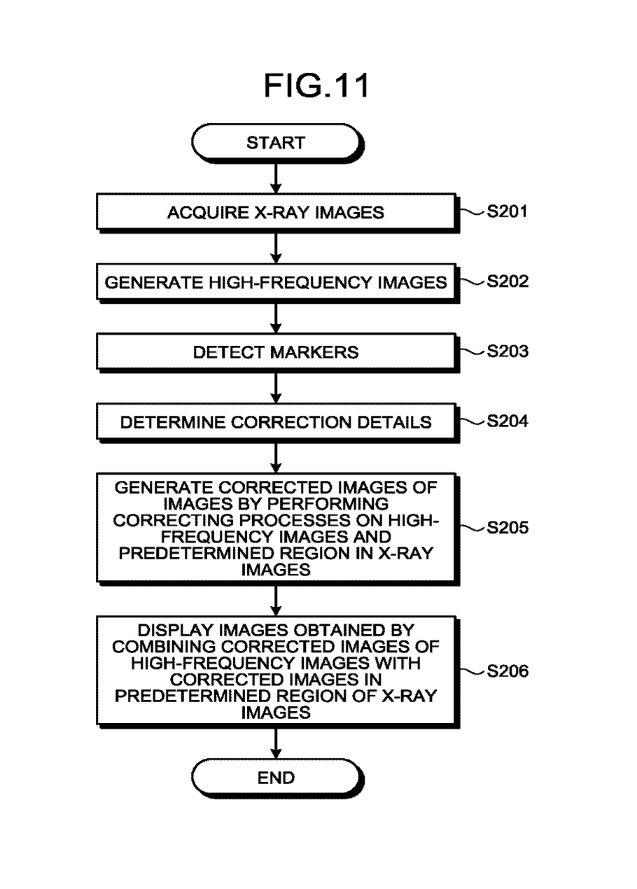

Next, a process performed by the X-ray diagnosis apparatus 100 according to the second embodiment will be explained, with reference to FIG. 11. FIG. 11 is a flowchart illustrating a processing procedure performed by the X-ray diagnosis apparatus 100 according to the second embodiment. In FIG. 11, step S201 is a step at which the processing circuitry 21 reads and executes the program corresponding to the controlling function from the storage circuitry 25. Further, steps S202 and S203 are steps at which the processing circuitry 21 reads and executes the program corresponding to the detecting function 211 from the storage circuitry 25. Step S204 is a step at which the processing circuitry 21 reads and executes the program corresponding to the determining function 212 from the storage circuitry 25. Further, step S205 is a step at which the processing circuitry 21 reads and executes the program corresponding to the corrected image generating function 213 from the storage circuitry 25. Step S206 is a step at which the processing circuitry 21 reads and executes the program corresponding to the display controlling function 214 from the storage circuitry 25.

At step S201, the processing circuitry 21 acquires X-ray images. At steps S202 and S203, the processing circuitry 21 generates a high-frequency image from each of the acquired X-ray images and further detects the markers included in each of the high-frequency images. At step S204, on the basis of the positions of the markers detected by using the high-frequency images, the processing circuitry 21 determines correction details of correcting processes to perform image deforming processes on the X-ray images.

At step S205, the processing circuitry 21 generates corrected images of the images by performing the correcting processes determined by using the high-frequency images, on the high-frequency images and the predetermined region in the X-ray images. At step S206, the processing circuitry 21 causes the display 23 to display corrected images obtained by combining the corrected images of the high-frequency images with the corrected images of the predetermined region in the X-ray images, as a moving picture.

As explained above, according to the second embodiment, the detecting function 211 generates the frequency image including the predetermined frequency component from each of the sequentially-generated X-ray images and further detects the position of the object included in each of the plurality of generated frequency images. While using the position of the object detected from the reference image included in the plurality of reference images as the reference position, the determining function 212 determines the processing details of the correcting process performed to arrange the position of the object detected from the newly-generated frequency image to match the reference position. The corrected image generating function 213 sequentially generates the corrected images each obtained by combining the first partial image resulting from the correcting process according to the processing details determined by the determining function 212 performed on the predetermined region within the X-ray image from which the newly-generated frequency image was generated, with the second partial image resulting from the correcting process according to the processing details determined by the determining function 212 performed on the region different from the predetermined region within the newly-generated frequency image. The display controlling function 214 causes the display 23 to display the corrected images sequentially generated by the corrected image generating function 213, as the moving picture. Consequently, the X-ray diagnosis apparatus 100 according to the second embodiment is able to display the images rendering the lesion site while the device is displayed in the enhanced manner, in the moving picture in which the device virtually appears to be stationary. The X-ray diagnosis apparatus 100 according to the second embodiment thus makes it possible to improve the visibility of the device and the lesion site.

As explained above, according to the second embodiment, the predetermined region is the region including the region positioned between the two or more markers. Consequently, the X-ray diagnosis apparatus 100 according to the second embodiment makes it possible to easily set the region including the lesion site automatically.

### Third Embodiment

The first and the second embodiments have thus been explained. The present disclosure, however, may be carried out in various different forms other than those described in the first and the second embodiments.

In the embodiments above, the example is explained in which the calcified site (the calcified component) is used as the lesion site; however, possible embodiments are not limited to this example. It is also possible to use a thrombosis or a plaque as a lesion site.

Further, in the embodiments above, the example is explained in which the frequency images are generated as the enhanced images; however, possible embodiments are not limited to this example. For instance, it is also acceptable to generate images each including a predetermined brightness value as the enhanced images. In that situation, the detecting function 211 generates, as the enhanced images, images in each of which brightness values other than brightness values indicating an object (e.g., the stent markers) are replaced with a predetermined brightness value (e.g., a brightness value “0”). With this arrangement, the detecting function 211 is able to generate the enhanced images in which the object is enhanced.

Further, in the embodiments above, the example is explained in which the X-ray diagnosis apparatus 100 performs the processes; however, possible embodiments are not limited to this example. For instance, an image processing apparatus may perform the processes described above. In that situation, for example, the image processing apparatus obtains the X-ray images via a network and performs the processes described above on the obtained X-ray images. In other words, the image processing apparatus includes processing circuitry configured to execute the same functions as those executed by the processing circuitry 21 described above. Further, the processing circuitry included in the image processing apparatus executes the detecting function 211, the determining function 212, the corrected image generating function 213, and the display controlling function 214 described above, on the obtained X-ray images.

Further, the constituent elements of the apparatuses illustrated in the drawings in the first embodiment are based on functional concepts. Thus, it is not necessary to physically configure the constituent elements as indicated in the drawings. In other words, the specific modes of distribution and integration of the apparatuses are not limited to those illustrated in the drawings. It is acceptable to functionally or physically distribute or integrate all or a part of the apparatuses in any arbitrary units, depending on various loads and the status of use. Further, all or an arbitrary part of the processing functions performed by the apparatuses may be realized by a CPU and a computer program analyzed and executed by the CPU or may be realized as hardware using wired logic.

Further, it is possible to realize the displaying method explained in the above embodiments, by causing a computer such as a personal computer or a workstation to execute a displaying computer program (hereinafter, “displaying program”) prepared in advance. It is possible to distribute the displaying program via a network such as the Internet. Further, the displaying program may be executed as being recorded on a computer-readable recording medium such as a hard disk, a flexible disk (FD), a Compact Disk Read-Only Memory (CD-ROM), a Magneto-Optical (MO) disk, a Digital Versatile Disk (DVD), or the like and being read from the recording medium by a computer.

As explained above, according to at least one aspect of the embodiments, it is possible to improve the visibility of the lesion site.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising processing circuitry configured to:
generate an enhanced image in which an object is enhanced from each of sequentially-generated X-ray images;
detect a position of the object included in each of the generated enhanced images;
determine, while using the position of the object detected from a specific one of the generated enhanced images as a reference position, processing details of a correcting process performed to arrange the detected position of the object to match the reference position, with respect to each of the enhanced images generated after the specific enhanced image;
sequentially generate corrected images by performing the correcting processes according to the processing details determined for each of the enhanced images, on the X-ray images from which the enhanced images were generated; and
cause a display to display the sequentially-generated corrected images as a moving picture.

2. The image processing apparatus according to claim 1, wherein each of the enhanced images is generated by performing a process of extracting a predetermined frequency component or performing a process of converting pixel value for extracting a pixel having a predetermined brightness value.

3. The image processing apparatus according to claim 2, wherein the predetermined frequency component is extracted by performing a process of extracting a component corresponding to the object.

4. An image processing apparatus comprising a processing circuitry configured to:
generate an enhanced image in which an object is enhanced from each of sequentially-generated X-ray images;
detect a position of the object included in each of the generated enhanced images;
determine, while using the position of the object detected from a specific one of the generated enhanced images as a reference position, processing details of a correcting process performed to arrange the detected position of the object to match the reference position, with respect to each of the enhanced images generated after the specific enhanced image;
sequentially generate corrected images each of which is generated by combining a part of a different one of the enhanced images generated after the specific enhanced image with a part of the X-ray image from which the enhanced image was generated and in each of which the position of the object is arranged to match the reference position by performing the correcting process according to the processing details determined for a corresponding one of the enhanced images; and
cause a display to display the sequentially-generated corrected images as a moving picture.

5. The image processing apparatus according to claim 4, wherein each of the enhanced images is generated by performing a process of extracting a predetermined frequency component or performing a process of converting pixel value for extracting a pixel having a predetermined brightness value.

6. The image processing apparatus according to claim 5, wherein the predetermined frequency component is extracted by performing a process of extracting a component corresponding to the object.

7. The image processing apparatus according to claim 4, wherein the part of the X-ray image from which the enhanced image was generated includes a region positioned between two or more objects.

8. An X-ray diagnosis apparatus comprising a processing circuitry configured to:
sequentially generate X-ray images on a basis of X-rays that are radiated from an X-ray tube and have passed through a subject;
generate an enhanced image in which an object is enhanced from each of the sequentially-generated X-ray images;
detect a position of the object included in each of the generated enhanced images;
determine, while using the position of the object detected from a specific one of the generated enhanced images as a reference position, processing details of a correcting process performed to arrange the detected position of the object to match the reference position, with respect to each of the enhanced images generated after the specific enhanced image;
sequentially generate corrected images by performing the correcting processes according to the processing details determined for each of the enhanced images, on the X-ray images from which the enhanced images were generated; and
cause a display to display the sequentially-generated corrected images as a moving picture.

9. The X-ray diagnosis apparatus according to claim 8, wherein each of the enhanced images is generated by performing a process of extracting a predetermined frequency component or performing a process of converting pixel value for extracting a pixel having a predetermined brightness value.

10. The X-ray diagnosis apparatus according to claim 9, wherein the predetermined frequency component is extracted by performing a process of extracting a component corresponding to the object.

11. An X-ray diagnosis apparatus comprising a processing circuitry configured to:
sequentially generate X-ray images on a basis of X-rays that are radiated from an X-ray tube and have passed through a subject;
generate an enhanced image in which an object is enhanced from each of the sequentially-generated X-ray images;
detect a position of the object included in each of the generated enhanced images;
determine, while using the position of the object detected from a specific one of the generated enhanced images as a reference position, processing details of a correcting process performed to arrange the detected position of the object to match the reference position, with respect to each of the enhanced images generated after the specific enhanced image;
sequentially generate corrected images each of which is generated by combining a part of a different one of the enhanced images generated after the specific enhanced image with a part of the X-ray image from which the enhanced image was generated and in each of which the position of the object is arranged to match the reference position by performing the correcting process according to the processing details determined for a corresponding one of the enhanced images; and
cause a display to display the sequentially-generated corrected images as a moving picture.

12. The X-ray diagnosis apparatus according to claim 11, wherein each of the enhanced images is generated by performing a process of extracting a predetermined frequency component or performing a process of converting pixel value for extracting a pixel having a predetermined brightness value.

13. The X-ray diagnosis apparatus according to claim 12, wherein the predetermined frequency component is extracted by performing a process of extracting a component corresponding to the object.

14. The X-ray diagnosis apparatus according to claim 11, wherein the part of the X-ray image from which the enhanced image was generated includes a region positioned between two or more objects.
